(19) United States
(12) Patent Application Publication
(10) Pub. No.: US 2025/0296419 A1
(43) Pub. Date: Sep. 25, 2025

(54) Energy Store Floor Structure for an Electrically Drivable Motor Vehicle

(71) Applicant: Bayerische Motoren Werke Aktiengesellschaft, Muenchen (DE)

(72) Inventors: Jan DANNEBERG, Muenchen (DE); Martin GAMBONI, Eurasburg (DE); Juergen LESCHHORN, Geltendor (DE); Emanuel PREIS, Muenchen (DE); Andreas WOLF, Muenchen (DE)

(21) Appl. No.: 18/868,925

(22) PCT Filed: Jun. 30, 2023
(86) PCT No.: PCT/EP2023/067957

§ 371 Date: Nov. 25, 2024

(30) Foreign Application Priority Data
Jul. 29, 2022 (DE) 10 2022 119 161.3

(51) Int. Cl. B60K 1/04; H01M 50/249; H01M 50/264

(52) U.S. Cl. CPC B60K 1/04; H01M 50/249; H01M 50/264; B60K 2001/0438

(57) ABSTRACT

An energy store floor structure for an electrically drivable motor vehicle, includes: a floor structure which has associated longitudinal and transverse members; and an electrical energy store device which has a store housing disposed on the underside of the floor structure. The store housing is connected to the associated longitudinal or transverse member of the floor structure at least in a length region along a fastening plane by way of mechanical connectors and is sealed against the corresponding longitudinal or transverse member of the floor structure at least in the length region along a sealing plane by way of a seal. In order to create an energy store floor structure in which the store housing is protected against excessive deformation and cell intrusions, the fastening plane and the sealing plane are mutually spaced apart in the corresponding length region.

### BACKGROUND AND SUMMARY

The invention relates to an energy storage unit floor structure for an electrically drivable motor vehicle.

An energy storage unit floor structure of this type according to the prior art is illustrated in FIG. 1 in a partial sectional view along a sectional plane extending in the transverse direction of the vehicle and in the vertical direction of the vehicle respectively. The figure shows a storage unit housing 2 of an electrical energy storage device 1 for an electric drive of the motor vehicle, this storage unit housing essentially being composed of an upper part 3 and a lower part 4, via which the storage unit housing 2 is connected in an external longitudinal region to a lateral longitudinal member or side skirt by means of respective screw connections 7. The side skirt is composed of a plurality of sheet metal casing elements, for example an inner part 9, an outer part 10 and an angled part 11. Shown in the interior of the side skirt is a deformation element 12 which, in the event of vehicle impact, in particular a pole-type impact, allows the corresponding accident forces, which are indicated in the present case by the dashed arrow F, to be absorbed and transmitted toward the center of the vehicle. The flange connection 5 is attached to the side skirt via the inner angled part 11 by means of the screw connections 7.

As also shown in FIG. 1, a fixing plane FE, indicated by a correspondingly dash-dotted line, is formed by the combination of the angled part 11 and the flange connection 5 of the storage unit housing 2. Moreover, a sealing element 13, which extends around the outer circumference of the storage unit housing 2, is arranged on the inner side of the screw connections 7 between the angled part 11 and the flange connection 5 of the storage unit housing 2. Since this sealing element 13 is also located between the angled part 12 and the flange connection 5, the corresponding sealing plane DE is therefore congruent in the present case with the sealing plane FE. In other words, the fixing plane FE and the sealing plane DE are located in a common plane.

If, as described above, a side impact then occurs and the corresponding forces F are applied, the screw connections 7 are prone to forming blocks, with the result that these screw connections, together with the angled part 11 and the flange connection 5, are in some circumstances displaced relatively far toward the center of the vehicle in the transverse direction of the vehicle, with the result that a safe width B to the energy storage device I may be breached and considerable deformation and cell intrusion of the storage unit housing 2 may occur. A further disadvantage is that arranging the sealing element 13 on the inner side of the screw connections 7 in the common fixing plane FE and sealing plane DE causes the flange connection 5 and the angled part 11 to extend considerably in the transverse direction (y-direction) of the vehicle, which in turn further increases the risk of corresponding cell intrusions.

The object of the present invention is therefore to provide an energy storage unit floor structure which provides greater security against corresponding damage to the storage unit housing and/or cell intrusions.

This object is achieved according to the invention by an energy storage unit floor structure with the features of the independent claim(s). Favorable developments of the invention form the subject matter of the dependent claims.

The energy storage unit floor structure according to the invention for an electrically drivable motor vehicle comprises, on the one hand, a floor structure having respective longitudinal and transverse members and, on the other hand, an electrical energy storage device comprising a storage unit housing, which is arranged on the underside of the floor structure, to which the respective longitudinal and transverse members of the floor structure are connected, at least in a longitudinal region along a fixing plane, by mechanical connectors, and which is sealed against the corresponding longitudinal or transverse member of the floor structure, at least in the longitudinal region along a sealing plane, by a seal. In order to provide an energy storage unit floor structure in which the storage unit housing is particularly favorably protected against excessive deformation and cell intrusion, the fixing plane and the sealing plane are arranged according to the invention at a distance from one another in the corresponding longitudinal region. Therefore, the essence of the invention is the separation of the fixing plane from the sealing plane, or rather the fact that the fixing plane can be positioned outside a transverse load path along which forces act in the transverse direction of the vehicle in the event of an accident-induced application of force caused by a side impact, in particular a pole-type side impact. In particular, separating the fixing plane from the sealing plane makes it possible to reduce the size of the connection between the storage unit housing and the corresponding longitudinal or transverse member of the floor structure, and thus to increase the available width, for example in the event of a side collision of the motor vehicle. This creates, for example, a deformation region in the connection region between the storage unit housing and the floor structure, this deformation region allowing deformation to take place without intrusions into the storage device 1.

In a further configuration of the invention, it has proved to be advantageous if the fixing plane and the sealing plane extend at least substantially parallel to each other in the longitudinal direction of the vehicle and in the transverse direction of the vehicle. This makes it possible to achieve a corresponding separation of the fixing plane and the sealing plane, in particular in the vertical direction of the vehicle, which contributes to the reduction according to the invention of the risk of intrusion into the energy storage device.

Furthermore, it has proved to be advantageous if the sealing plane is arranged above the fixing plane in the vertical direction of the vehicle. The fixing plane is thus shifted downward, so that corresponding mechanical connectors, in particular screw connections, can be arranged at a greater distance from the corresponding cells of the energy storage unit.

Furthermore, it has proved to be advantageous if the mechanical connectors in the fixing plane are designed as screw connections. Screw connections of this type provide a particularly reliable connection with the floor structure in the fixing plane.

Furthermore, it has proved to be advantageous if the screw connections are arranged, in relation to the vertical direction of the vehicle, so as to at least substantially overlap a main profile of the respective longitudinal or transverse member of the floor structure. This means that the respective screw connections are for example arranged so as to be offset so far outward in the transverse direction of the vehicle that they overlap or are located below the respective longitudinal member or side skirt, as viewed in the vertical direction of the vehicle. This makes it possible to achieve a particularly favorable width or distance between the screw connections and the energy storage device.

Furthermore, it has proved to be advantageous if a flange between an upper part and a lower part of the storage unit housing is located in the fixing plane of the storage unit housing to the floor structure. As a result of the flange connection of the upper part and the lower part of the storage unit housing, this provides a particularly stable connection to the corresponding side skirt of the floor structure by means of the respective mechanical connectors.

Finally, it has proved to be advantageous if the upper part of the storage unit housing, at least in certain regions, forms the vehicle floor of the body in the region of the passenger compartment. This achieves an underbody which is particularly favorable in terms of weight.

Further features of the invention can be found in the claims, the figures and the description of the figures. The features and combinations of features mentioned above in the description and also those mentioned below in the description of the figures and/or shown solely in the figures may be used not only in the combination specified in each case, but also in other combinations or alone.

The invention will now be explained in greater detail on the basis of a preferred exemplary embodiment with reference to the drawings.

### BRIEF DESCRIPTION OF THE DRAWINGS

FIG. 1 shows a partial sectional view along a sectional plane, extending in the transverse direction of the vehicle and in the vertical direction of the vehicle respectively, through an energy storage unit floor structure according to the prior art, in which a storage unit housing of an energy storage device for an electric drive of the motor vehicle is connected by screw connections in the region of a fixing plane to a side skirt of a floor structure of the motor vehicle body and is sealed against the side skirt along a sealing plane by a seal, wherein the fixing plane and the sealing plane are located on top of one another;

FIG. 2 shows a partial sectional view along a sectional plane, extending in the transverse direction of the vehicle and in the vertical direction of the vehicle respectively, through an energy storage unit floor structure according to an embodiment of the invention, comprising a storage unit housing which is connected by screw connections to the side skirt of a floor structure along a fixing plane and is sealed against the side skirt along a sealing plane by a seal, wherein the fixing plane and the sealing plane are arranged at a distance from one another in the vertical direction of the vehicle; and

FIG. 3 shows a partial, perspective sectional view through the energy storage unit floor structure along a sectional plane, extending in the transverse direction of the vehicle and in the vertical direction of the vehicle, respectively, similar to FIG. 2.

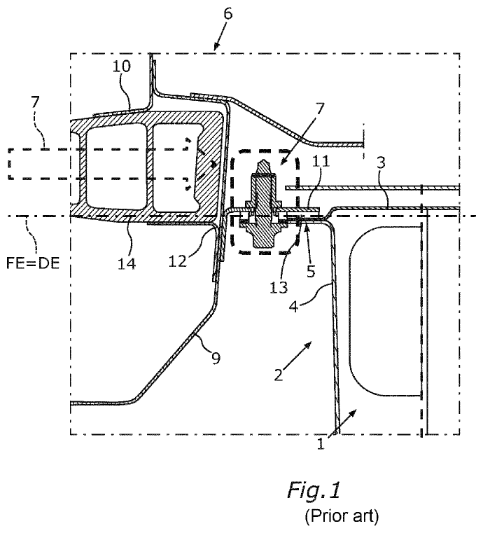

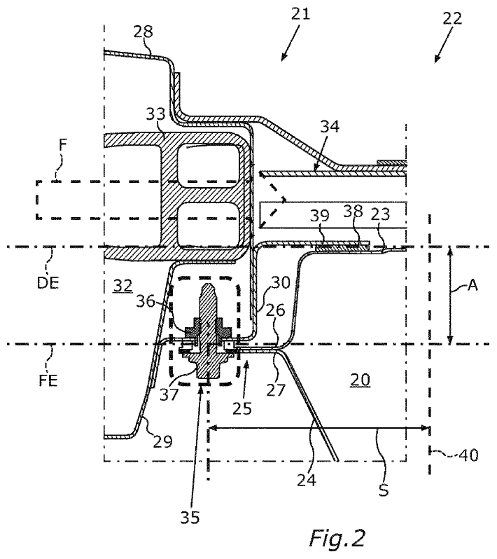

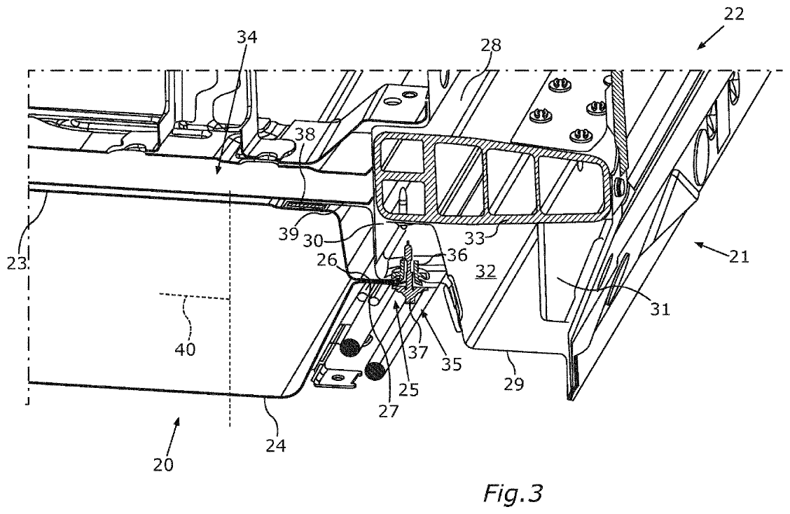

### DETAILED DESCRIPTION OF THE DRAWINGS

Whereas FIG. 1 is a sectional view of an energy storage unit floor structure according to the prior art as described above, FIGS. 2 and 3 are a partial sectional view and a partial perspective sectional view, respectively, of an energy storage unit floor structure taken along a sectional plane extending in the transverse direction (y-direction) of the vehicle and in the vertical direction (z-direction) of the vehicle. FIG. 2 shows the connection of a storage unit housing 20 to a side skirt 21 of a floor structure 22 on one of the outer or longitudinal sides of the vehicle, for example on the right outer side of the vehicle, as viewed in the direction of forward travel, whereas FIG. 3 shows the same connection of the storage unit housing 20 to the side skirt 21 of the floor structure 22 on the opposing outer or longitudinal side of the vehicle, i.e., in the present case, for example, on the left outer side of the vehicle, as viewed in the direction of forward travel.

In the present case, the storage unit housing 20 acts to receive a multiplicity of storage cells or battery modules of an energy storage device 23 for an electric drive of the passenger car, which in the present case is arranged below the floor structure 22 in an underfloor construction known per se. The storage unit housing 20 comprises an upper part 23 and a lower part 24, which are connected to each other around the outer circumference in the region of a flange connection 25 via respective flanges 26, 27. FIGS. 2 and 3 therefore respectively show a longitudinal region of the flange connection 25 and a longitudinal region of the flanges 26, 27 of the storage unit housing 20, this region extending on the respective vehicle outer side along the corresponding side skirt 21. In the front and rear regions of the storage unit housing 20, an analogous connection to the floor structure is established via respective transverse members (not shown), which are used to connect the respective side skirts 21 to each other. The present floor structure is therefore formed in a manner known per se from respective longitudinal members or side skirts 21 and the associated transverse members, which extend between the side skirts 21.

In each case, the side skirt 21 itself is shown as an assembly of respective elements, in particular an upper element 28, lower inner casing elements 29, 30 and an outer casing element 31, these elements forming a box profile with a cavity 32, within which an extruded profile is arranged as a deformation element 33. This deformation element 33 is arranged in the vertical direction (z-direction) of the vehicle at a height of a vehicle floor which is, however, in the present case at least partially formed by the upper part 23 of the storage unit housing 20. For this purpose, the storage unit housing 20 is arranged with the upper part 23 thereof fastened to the underside of respective transverse members 34, which are located at a distance from one another in the longitudinal direction (x-direction) of the vehicle and each extend in the transverse direction (y-direction) of the vehicle between the side skirts 21. In the present case, therefore, the upper part 23 of the storage unit housing 20 forms the main floor of the vehicle floor, which extends for example from a front end wall of the passenger compartment, comprising an associated lower end wall transverse member, toward the rear to a heel wall below a rear row of vehicle seats of the motor vehicle body. However, the scope of the invention is deemed to include an energy storage unit floor structure design in which a separate vehicle floor, not formed by the upper part of the storage unit housing, could be provided.

In the present case, however, the deformation element 33 extends, as shown in FIGS. 2 and 3, at the height of the respective longitudinal members 34 of the floor structure, the corresponding longitudinal members or side skirts 21.

As also shown in FIGS. 2 and 3, the storage unit housing 20 is respectively connected via a flange connection 25 and via flanges 26, 27 of the upper part 23 and lower part 24 to the sheet metal casing element 30 of the side skirt 21 via respective mechanical connectors in the form of screw connections 35. In the present case, these screw connections 35 comprise a screw sleeve 36 attached to the sheet metal casing element 30 and a screw 37, which passes through the flange connection 25 of the storage unit housing 20. The storage unit housing 20 is therefore connected in this manner over at least approximately the entire longitudinal region of the storage unit housing 20 or the corresponding side skirt 21 along a fixing plane FE, which is consequently at least substantially horizontal in the longitudinal direction (x-direction) of the vehicle and in the transverse direction (y-direction) of the vehicle in the region of contact between the flange connection 25 and the sheet metal casing element 30.

Furthermore, FIGS. 2 and 3 show that the upper part 23 of the storage unit housing 20 is sealed via a seal 38 against a leg 39 of the sheet metal casing element 30 at a laterally offset distance toward the interior in the transverse direction of the vehicle (y-direction). The sheet metal casing element 30 extends over at least approximately the entire longitudinal region of the storage unit housing 20 or the corresponding side skirt 21 along a sealing plane DE which extends, at least substantially horizontally, in the longitudinal direction (x-direction) of the vehicle and in the transverse direction (y-direction) of the vehicle. The storage unit housing 20 is thus sealed against the floor structure 22 by means of the seal 38. In the present case, as shown in FIGS. 2 and 3, the storage unit housing is sealed against the side skirt 21 on the corresponding side in each case. In the front and rear regions, the storage unit housing 20 is respectively fixed and sealed in a similar manner within the same fixing plane FE and sealing plane DE, by means of corresponding screw connections 35, which are screwed against a front and rear transverse member, and by the circumferential seal 38, which is then also arranged at a distance before or after the corresponding screw connections 35.

The figures show that, in the present case, the fixing plane FE and the sealing plane DE are arranged at a distance A from each other in the vertical direction (z-direction) of the vehicle in the corresponding longitudinal region in each case-in the present case approximately over the respective length of the storage unit housing 20, of the associated side skirt 21. In contrast to the prior art shown in FIG. 1, in which fixing and sealing are carried out within a single plane, in the present case a vertical distance is thus provided between the fixing plane FE and the sealing plane DE, so that, in the present case, the respective screw connections 35 are arranged, in relation to the vertical direction (z-direction) of the vehicle, i.e., as viewed in the vertical direction (z-direction) of the vehicle or, for example, from top to bottom, so as to at least substantially overlap a corresponding main profile, which forms the cavity of the side skirt 21. In the present case, the screw connections 35 are therefore arranged below the deformation element 33 so as to overlap the latter when viewed in the vertical direction (z-direction) of the vehicle. In contrast, the sealing plane DE is at the height of the lower end of the deformation element 33. Due to the height offset A between the fixing plane FE and the sealing plane DE, the respective screw connections 35 can thus for example be arranged closer to the exterior of the vehicle and in an overlapping manner with the associated side skirt 21, so that an increased lateral distance S is obtained between the respective screw connections 35 and respective cells of the energy storage device, which are indicated by a dashed line 40. Since the screw connections 35 are thus not located in the same plane as the seal 38, they can be arranged closer to the exterior of the vehicle and closer to the corresponding side skirt 21 respectively. The fixing plane FE is therefore shifted downward and outward along the side skirt 21 so that this plane is no longer located in the transverse load path indicated by the arrow F in the event of an accident-induced side impact, thus providing a greater distance to the respective cells of the energy storage unit in the transverse direction (y-direction) of the vehicle. This produces a deformation region in the region of the storage unit housing 20, which allows deformation to take place without intrusions into the cells.

The distance between the fixing plane FE and the sealing plane DE is selected in such a way that the screw connections 35 provide the necessary contact pressure and press the seal 38 correspondingly against the leg 39 of the sheet metal casing element 30.

### LIST OF REFERENCE SIGNS

20 storage unit housing
21 side skirt
22 floor structure
23 upper part
24 lower part
25 flange connection
26 flange
27 flange
28 sheet metal casing element
29 sheet metal casing element
30 sheet metal casing element
31 sheet metal casing element
32 cavity
33 deformation element
34 transverse member
35 screw connections
36 screw sleeve
37 screw
38 seal
39 leg
40 line/cells
F force
A vertical distance
S lateral distance

1-8. (canceled)

9. An energy storage unit floor structure for an electrically drivable motor vehicle, comprising:
a floor structure having longitudinal and transverse members; and
an electrical energy storage device comprising a storage unit housing which is arranged on an underside of the floor structure, is connected to a respective longitudinal or transverse member of the floor structure at least in a longitudinal region along a fixing plane by mechanical connectors, and is sealed against the corresponding longitudinal or transverse member of the floor structure at least in a longitudinal region along a sealing plane by a seal,
wherein the fixing plane and the sealing plane are arranged at a distance from each other in the corresponding longitudinal region.

10. The energy storage unit floor structure according to claim 9, wherein
the fixing plane and the sealing plane extend at least substantially parallel to each other in a longitudinal direction of the vehicle and in a transverse direction of the vehicle.

11. The energy storage unit floor structure according to claim 9, wherein
the sealing plane is arranged above the fixing plane in a vertical direction of the vehicle.

12. The energy storage unit floor structure according to claim 9, wherein
the mechanical connectors in the fixing plane are screw connections.

13. The energy storage unit floor structure according to claim 12, wherein
the screw connections are arranged, in relation to the vertical direction of the vehicle, so as to at least substantially overlap a main profile of the respective longitudinal or transverse member of the floor structure.

14. The energy storage unit floor structure according to claim 12, wherein
the screw connections are arranged, in relation to the vertical direction of the vehicle, substantially below a load path of the floor structure.

15. The energy storage unit floor structure according to claim 9, wherein
a flange between an upper part and a lower part of the storage unit housing is located in the fixing plane of the storage unit housing to the floor structure.

16. The energy storage unit floor structure according to claim 15, wherein
the upper part of the storage unit housing, at least in certain regions, forms a vehicle floor of a body of the vehicle in a region of a passenger compartment.
